(19) United States
(12) Patent Application Publication
(10) Pub. No.: US 2009/0031151 A1
(43) Pub. Date: Jan. 29, 2009

(54) INFORMATION TERMINAL DEVICE AND OPTION UNIT THEREFOR

(75) Inventors: Koichi Masuda, Ome-shi (JP); Tomozo Murayama, Hachioji-shi (JP); Toshiaki Takahashi, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/171,872

(22) Filed: Jul. 11, 2008

(30) Foreign Application Priority Data
Jul. 24, 2007 (JP) 2007-192281

(51) Int. Cl. G06F 1/00

(52) U.S. Cl. 713/300

(57) ABSTRACT

According to one embodiment, there is provided an information terminal device which receives power via a communication cable from a power sourcing device recognizes a class identifying power-sourcing characteristics on the basis of response characteristics to a defined value voltage given in authentication and which is configured to connect an option unit. The information terminal device comprises a resistor unit which is disposed on a power sourcing line from the communication cable and configured to vary a resistor value, a control unit which recognizes a class of the information terminal device itself and sets a resistor value in order to achieve response characteristics corresponding to the recognized class, and a storing unit which stores the set resistor value.

### CROSS-REFERENCE TO RELATED APPLICATIONS

This application is based upon and claims the benefit of priority from Japanese Patent Application No. 2007-192281, filed Jul. 24, 2007, the entire contents of which are incorporated herein by reference.

### BACKGROUND

1. Field

One embodiment of the present invention relates to an information terminal device which is supplied power via a communication cable such as a local area network (LAN) cable, and an option unit which is additionally provided for the device.

2. Description of the Related Art

A technique which supplies not only communication data but also power to an information terminal via the communication cable has been known. A representative technique of this kind utilizes the Ethernet (registered trademark) called the Power over Ethernet (PoE). The PoE is standardized as IEEE802.3af. This standard defines operation procedures in order to authenticate presence or absence of a power reception function of a terminal to be connected to a data communication network. In the standard, procedures to classify power reception terminals into a plurality of classes and individually classify the power reception terminals on the basis of a power sourcing quantity are defined. Each class includes an index to classify power sourcing characteristics for supplying power to the power reception terminals.

The procedures of classification firstly authenticate the power reception terminals. Next, procedures apply voltages at defined values to the power reception terminals, thereby; the classes of the power reception terminals are recognized by a power sourcing device (e.g., a hub) on the basis of measurement results of current quantities which have flowed by the applying. With the resistor values to be used in classification set to the power reception terminals in advance, an amount of current defined in IEEE802.3af are appropriately flowed and the power reception terminals may receive power sourcing corresponding to their power consumption.

Meanwhile, the option unit may be connected to the information terminal in order to extend its function. Especially, an information terminal device such as an Internet Protocol (IP) telephone set is used in such a use form in many cases. Since a whole of power consumption varies due to extension of option units, the class of PoE may be varied. If the option units are additionally provided just for low power classes, and if the power sourcing device cannot recognize this fact, since an operation failure occurs, some proper actions are required.

A related technique is disclosed in Jpn. Pat. Appln. KOKAI Publication No. 2006-352308. This patent document discloses a method for varying a power reception quantity class by connecting a device main unit and class setting resistors of the option units in parallel. However, the method is effective only in a case in which the change is made up to a first stage in many cases. That is, it is hard to flexibly cope with such a case in which the power reception quantity classes vary over many stages as the option units are further added after the device extension and it is limited with little freedom of extension of option units.

As mentioned above, it is necessary for the information terminal device to be supplied power via the communication cable to flexibly cope with the change in power reception quantity in extension of option units, and technical development for such a situation has been expected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view depicting an exterior appearance of an information terminal device;

FIG. 2 is a view depicting a power quantity class classification table of a PoE standard in IEEE802.3af;

FIG. 3 is a functional block diagram depicting a first embodiment of the information terminal device and an option unit;

FIG. 4 is a flowchart depicting a procedure in setting a power reception quantity class in the configuration of FIG. 3;

FIG. 5 is a functional block diagram depicting a relationship between the existing powered device (PD) (data communication terminal) and a concentrator 10 for comparing with each other;

FIG. 6 is a functional block diagram depicting a second embodiment of the information terminal device and the option unit; and

FIG. 7 is a functional block diagram depicting a third embodiment of the information terminal device and the option unit.

### DETAILED DESCRIPTION

Various embodiments according to the invention will be described hereinafter with reference to the accompanying drawings. In general, according to one embodiment of the invention, an information terminal device which receives power via a communication cable from a power sourcing device recognizes a class identifying power-sourcing characteristics on the basis of response characteristics to a defined value voltage given in authentication and which is configured to connect an option unit. The information terminal device comprises a resistor unit which is disposed on a power sourcing line from the communication cable and configured to vary a resistor value; a control unit which recognizes a class of the information terminal device itself and sets a resistor value in order to achieve response characteristics corresponding to the recognized class; and a storing unit which stores the set resistor value.

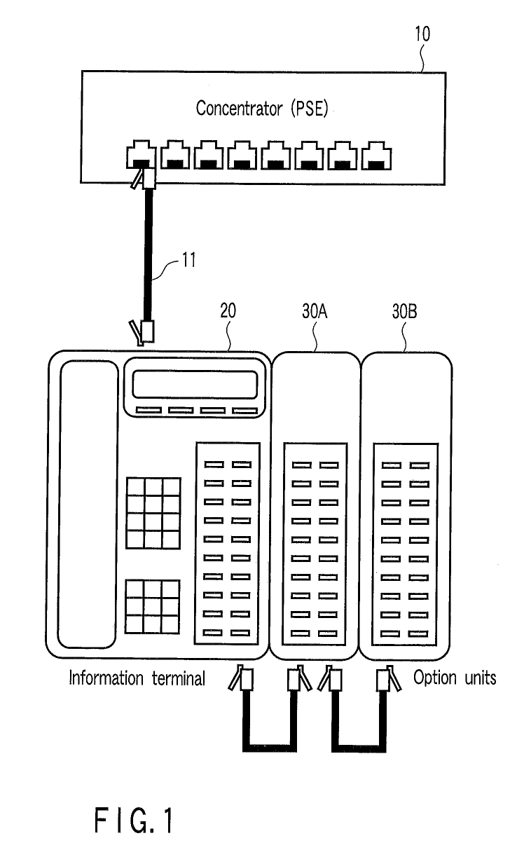

According to an embodiment, FIG. 1 shows a schematic view illustrating an exterior appearance of an information terminal device. An information terminal 20 includes a power reception function by means of LAN power sourcing, and equivalents to the information terminal device. An IP telephone set is representative as the information terminal 20. The IP telephone set makes communication by use of an IP network to be formed on a LAN. The information terminal 20 is connected a concentrator 10 via a LAN cable 11. The concentrator 10 is a so-called hub, and bears a function as a repeater. Thereby, the information terminal 20 may communicate with other terminals via the LAN.

The concentrator 10 supplies the information terminal 20 with drive power via the LAN cable 11. The concentrator 10 having this kind of function may be referred to as a power sourcing equipment (PSE). The concentrator 10 as the PSE is compliant with IEEE802.3af standard, and has at least three functions under this specification. That is, the three functions includes, a function of authenticating the powered device (PD) compliant with the specification, a class setting function of deciding a power sourcing level to the PD, and a power sourcing function of supplying power of a quantity based on a set power reception quantity class. In authentication processing, a voltage of a defined value is applied to the PD and response characteristics (impedance, current amount, etc.) which correspond to this voltage decide the power reception quantity class.

Option units may be connected to the information terminal 20 in response to user's need. Adding the option units enables expanding a telephone book function and increasing the number of registration of single-action keys. FIG. 1 shows a state in which an option unit 30A is connected to the information terminal 20, and further, an option unit 30B is connected thereto. The number of connections is not limited to two, the larger the number of the connections becomes, the larger a power consumption amount becomes as a whole. Therefore, the class defined by IEEE802.3af varies over a plurality of stages. Since the option units 30A, 30B each have not the LAN communication units 23, the option units 30A, 30B are recognized as parts of the information terminal 20, when the information terminal 20 with a LAN communication unit 23 is positioned as the PD.

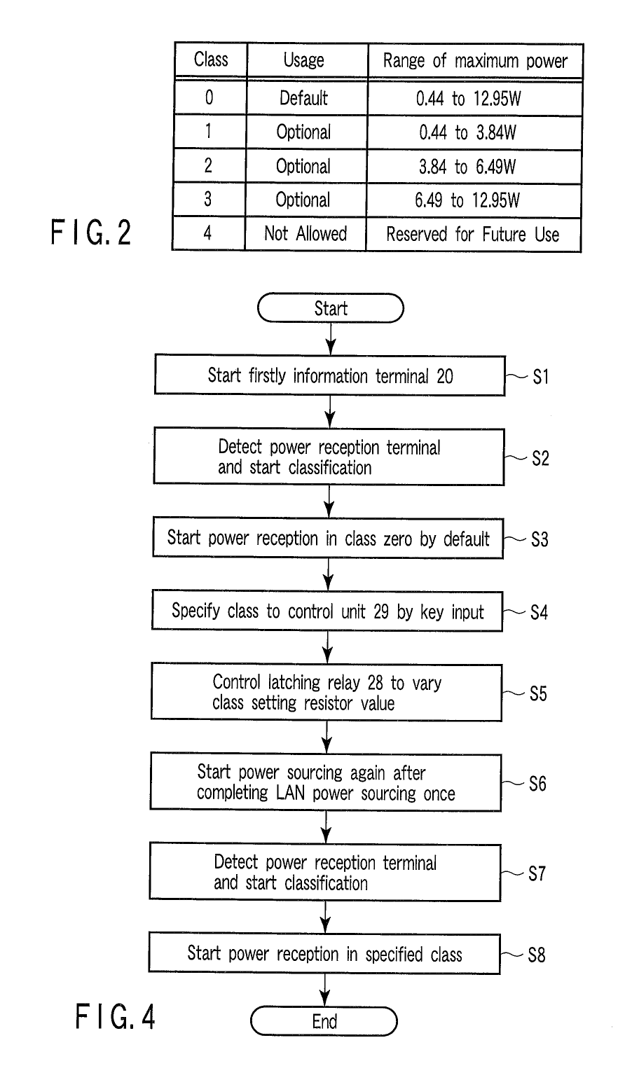

FIG. 2 shows a power quantity class classification table based on the PoE standard by IEEE802.3af. As shown in FIG. 2, this standard defines five classes from zero to four. Among of the classes, the class four has bee reserved for the future use. The class zero is prepared as the temporal use when any class is not set, and a maximum value of the widest supply power range is assigned in response to such temporal use. However maximum value of the in other classes are narrower than the maximum value of the widest supply power range, as the number of classes becomes larger, the larger power is assigned to the classes. Next, a plurality of embodiments will be described.

### FIRST EMBODIMENT

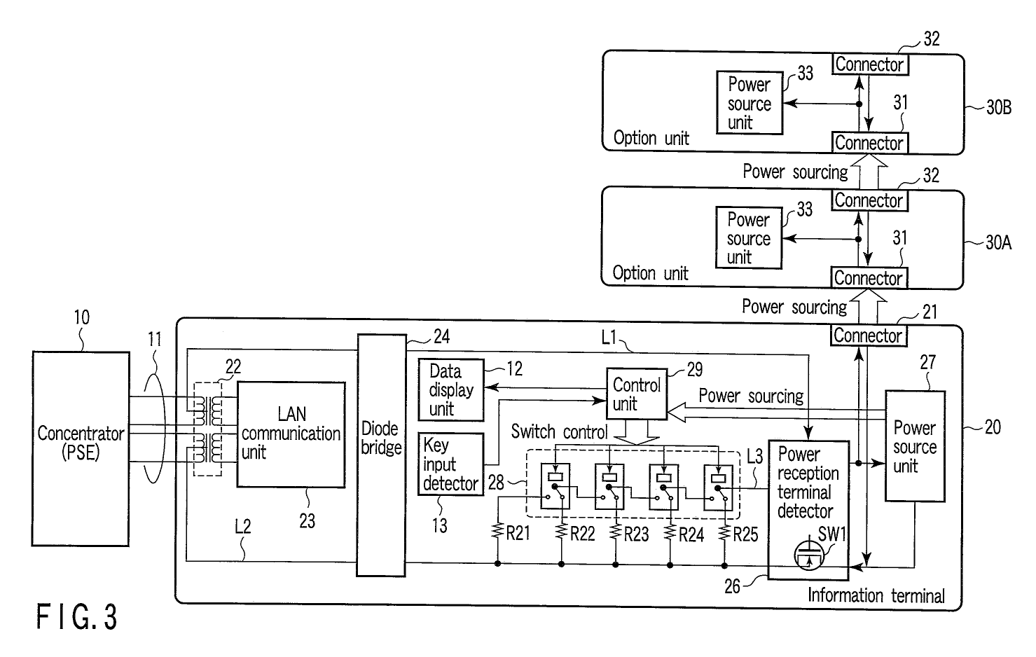

FIG. 3 shows a functional block diagram illustrating first embodiment of the information terminal device and the option unit of FIG. 1. In FIG. 3, the information terminal 20 is connected to the LAN cable 11 through a transformer 22 in the information terminal 20, and there is the concentrator 10 at the end of the LAN cable 11. The transformer 22 secures electrical isolation from the outside, and also becomes an interface to and from the LAN communication unit 23.

The voltage from the LAN cable 11 is applied to a diode bridge 24 from the transformer 22 via a power bus L2, and applied to a power reception terminal detector 26 via a power bus L1 after being detected and rectified. The detector 26 has a switch SW1, and power sourcing to the option units and a power source unit 27 is started after the switch SW1 is turned on. The detector 26 is connected to a latching relay 28 via a control bus L3.

The latching relay 28 includes a plurality of latch elements capable of storing a state of a switch without a power source, and each latch element is connected to a power bus in parallel through resistors R21-R25. The resisters R21-R25 form a resistor unit of which the resistor value is variable. A control unit 29 sets a state of latching relay 28. The control unit 29 also operates by receiving power from the power source unit 27. Other than this, a data display unit 12 and a key input detector 13 are connected to the control unit 29.

The information terminal 20 has a connector 21, and the connector 21 is connected to a connector 31 of the option unit 30A. The option units 30A, 30B each include connectors 31 for inputs and connectors 32 for outputs, and enable the extension of option units one by one by linking the connectors 31, 32 together. Each option unit includes a power source unit 33 between the connector 31 and the connector 32. The power source unit 33 generates drive power in the option unit from the power supplied from the information terminal 20. Of course, various kinds of data to be transferred to and from the information terminal 20 is also transmitted through the connectors 31, 32.

FIG. 4 shows a flowchart illustrating a procedure in setting the power reception quantity class in the configuration of FIG. 3. When the information terminal 20 is connected to the concentrator 10, first time start processing of the information terminal 20 is started (Block S1). That is, the processing for the first time power sourcing to the information terminal 20 is started. In this Block S1, the concentrator 10 applies a voltage of 2.8V-10V to the detector 26 through the transformer 22 and the diode bridge 24. Here, if the concentrator 10 detects impedance which is constant to the applied voltage, the concentrator 10 assumes to detect a power reception terminal and starts classification processing (Block S2).

That is, processing to detect resistor value in a rage of 23.75 kΩ-26.25 kΩ as PD authentication is performed. If the resistor value is detected in the defined range then the concentrator 10 applies a voltage of 15.5V-20.4V to the information terminal 20 to start the authentication of the power reception quantity class.

In this state, since the power of the defined value has not been supplied yet to the control unit 29, control such as a switchover of the latching relay 28 may not be performed. That is, until the defined power is supplied to the control unit 29, the information terminal 20 may not change a class setting resistor value by switching the latching relay 28. Therefore, the power sourcing corresponding to the default power reception quantity class zero (maximum power consumption range: 0.44 W-12.95 W) is performed (Block S3).

When the processes up to here have been completed, the power reception terminal detector 26 of the information terminal 20 turns on the switch SW1 and starts the power sourcing to the power source unit 27. Thereby, the power is also supplied to control unit 29, the control unit 29 may switch the latching relay 28 to set the class setting resistor value. In the first embodiment, the user operates manually to set the class setting resister value.

In other words, the information terminal 20 includes a plurality of push buttons such as ten keys and function keys, and when the user operates the buttons, the class is specified to be input to the information device 20 (Block S4). That is, the class of the information terminal 20 is not detected on a device side, but set to the information terminal 20 through the operation by the user. Inputting the concrete number of option units, inputting a total power consumption quantity in watts, or inputting the class levels themselves is a possible approach.

The key input detector 13 detects the operation content. The control unit 29 analyzes the operation content reported from the detector 13, recognizes the class of the information terminal 20 at a present time. The control unit 29 controls the latching relay 28 so as to respond to the class to switch the class setting resistor values (Block S5).

At this moment, a constant voltage is applied to the power bus L3 from the power reception detector 26. Connecting resistors (i.e., class setting resistors) capable of feeding currents of values defined in order to authenticate each power reception quantity class into power feeding paths between the power busses L3, L2 enables setting the power reception quantity class to the concentrator 10 (PSE).

After this, the user detaches the LAN cable 11 from the information terminal 20 once to stop feeding power. Thereby, however the information terminal 20 stops its operation, the state of the latching relay 28 is kept as it is if the power sourcing is stopped (Block S6). Re-connecting the information terminal 20 to the LAN cable 11 starts the processing from Block S2 again, and starts the terminal authentication and classification process (Block S7).

The state of the latching relay 28 has been varied from that of the first start, and an appropriate resistor value corresponding to the class has been set to the latching relay 28. Under the set resistor value, the concentrator 10 authenticates the power reception quantity class of the information terminal 20. That is, the set resistor value 10 achieves appropriate characteristics to the authentication from the concentrator 10, and the concentrator 10 appropriately recognizes the class of the information terminal 20. As a result, the information terminal 20 may receive appropriate power feeding from the concentrator 10 (Block S8).

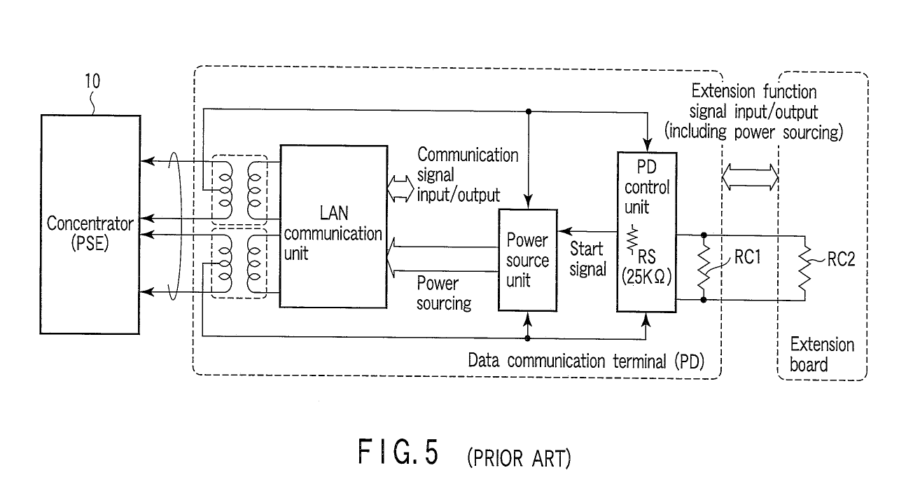

FIG. 5 shows a functional block diagram illustrating a relationship between the existing PD (data communication terminal) and the concentrator 10 for comparing therebetween. In the prior art, the class of a PD single unit is set on the basis of a value of its inner resistor RC1. In a state of extension of an extension board, parallel combined resistor value of the resistors RC1, RC2 inside the extension board are used for class authentication.

Since the resistor value may be varied into only two stages as a whole, the class authentication is limited to two stages. Even if the resistor RC2 is connected to an external slot so as to increase in the number of extension boards, as long as the resistors are connected in a ladder shape, the extension will reach the limit. Because, the combined resister value of the resistors connected in the ladder shape will become close to zero without limit. Therefore, the configuration in FIG. 5 may extend only on device about the most, and the configuration is not suitable for the use to connect a plurality of option units one by one and extend the system.

Since the class setting resister values vary at each time when the number of extension boards is increased in the system shown in FIG. 5, the kinds and the number to be connected is limited. Trying to relax this limit makes it hard to obtain the class setting resister value in order to authenticate the power reception quantity class corresponding to the maximum power consumption. Especially, the system may not respond to a case in which the power reception quantity classes corresponding to the maximum power consumption becomes three or more different levels.

In other words, if each maximum power consumption in a state in which the device single unit and one option unit is connected and a state in which a plurality of option units are connected differ from each other, the appropriate power reception quantity class also differ from each other for each state. In such a case, the power reception quantity class is set by fitting the power reception quantity class to the maximum power consumption corresponding to the maximum size of the information terminal device. That is, even if the power reception quantity class fitting to the power consumption of the device single unit and the power reception quantity class at the maximum size differ from each other, the power quantity necessary for maximum size may be supplied always. Therefore, the number of the PDs connectable to the PSE decreases in comparison with the number which is connectable originally.

In contrast, in the first embodiment, the information terminal device sets the power reception quantity class of the information terminal 20 mainly corresponding to the number of extended option units to the information terminal 20 through a manual operation by the user. That is, at the first start of the information terminal 20, the power sourcing in a default zero class; however, the information terminal 20 operates the control unit 29 by using the supplied power, recognizes the class corresponding the key input by the user, and sets the corresponding-resistor value to the latching relay 28. This setting is enabled only by the device main unit. After this, the information terminal 20 inserts/extracts the LAN cable 11 to execute again the class authentication processing; however, since the state of the latching relay 28 is maintained at a state after setting, the information terminal 20 completes the class authentication under the resister value corresponding to the set class. Therefore, regardless the number of option units, the power sourcing in an appropriate class corresponding to the power consumption quantity of the information terminal 20 is achieved.

In other words, as shown in FIG. 3, the information terminal 20 includes five resisters R21-R25 for class setting and the latching relay 28 for switching the resisters R21-R25, may switch on/off of each resister R21-R25 by the signal from the control unit 29. Since the information terminal 20 may select five resister values, the information terminal 20 also responds to vary the classes over three or more stages. Using the latching relay 28 capable of maintaining the state without power source, enables setting appropriate classes by two times of power reception quantity class due to the insertion/extraction of the LAN cable 11. Further, the information terminal 20 includes a data display unit 12 such as an LCD. Displaying the class setting resister values which are currently effective and the selectable class setting resister values on the display unit 12 allows the user to confirm that information at one view to set the class easily. Therefore, the first embodiment may provide an information terminal device configured to flexibly cope with the change in power reception quantity class and may provide an option unit therefor. The first embodiment also may improve the freedom degree of the extension of the option units.

### SECOND EMBODIMENT

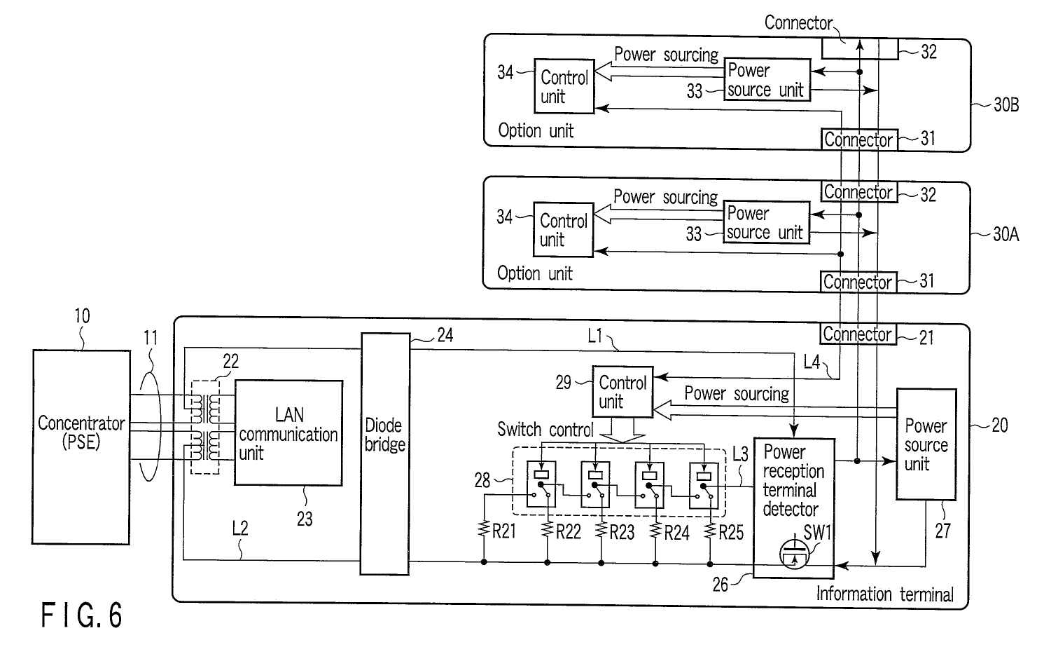

FIG. 6 shows a functional block diagram illustrating an information terminal device and option units therefor regarding the second embodiment. In FIG. 6, the same components as those of FIG. 2 are designated by the identical symbols and only different components will be described below.

In FIG. 6, each option unit 30A, 30B includes a control unit 34 such as a central processing unit (CPU) to which power is supplied from a power source unit 33. The control unit 34 has a function of communicating a variety of items of data with the control unit 29 of the information terminal 20 via a signal line L4.

The control unit 29 of the information terminal 20 acquires attribute data from each option unit 30A, 30B. The attribute data includes a kind, an individual power consumption quantity, etc., of an option unit. The control unit 29 reads information described in the acquired attribute data to determine the number of the option units (two in FIG. 6). The control unit 29 determines the class as a whole by combining the information terminal 20 and the option units 30A, 30B.

For determining, the control unit 29 may calculate the power consumption quantity as a whole to fit the calculation result to a class table. Preparing a table corresponding to the kinds and the number of the option units 30A, 30B in advance, or referring to the content is a possible approach.

After determining the class, the control unit 29 sets the latching relay 28 into a state for achieving the class setting resister value corresponding to the determined class, and then, the latching relay 28 maintains the set state. After this, by inserting/extracting the LAN cable 11, the concentrator 10 recognizes the class as a whole and power sourcing is started under the appropriate characteristics.

As mentioned above, in the second embodiment, the information terminal 20 detects the kinds and the number of the option units by means of data communication among the control unit 29 in the information terminal 20 and the control units 34 in the option units 30A, 30B. The control unit 29 determines the class of the information terminal at a current time point of the information terminal 20 from the detection result, and sets the class setting resister value on the basis of the determination result in an autonomous manner. Since the information terminal device is configured given above, the information terminal device may automatically switch the class setting resistors values and may allow the user to eliminate time and effort in manually setting the class.

### THIRD EMBODIMENT

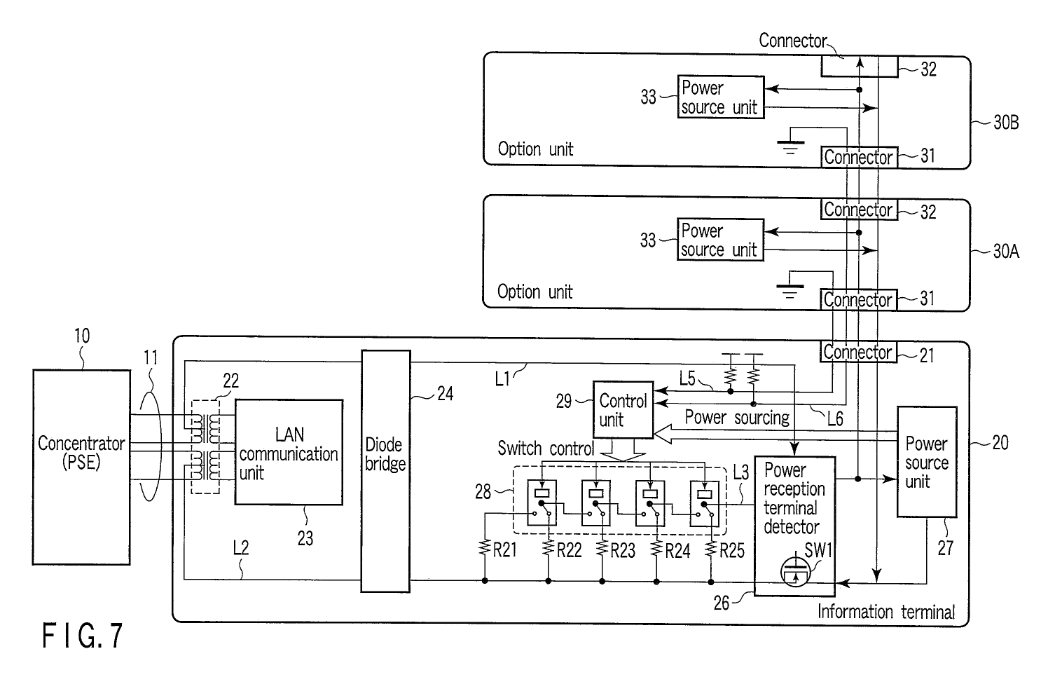

FIG. 7 shows a functional block diagram illustrating an information terminal device and option units regarding the third embodiment. In FIG. 7, the same components as those of FIG. 2 are designated by the identical symbols, and only different components will be described below. In FIG. 7, each of the connectors 21, 31, 32 has a form in a parallel bus shape, and has a plurality of connector pins. All the connector pins are not always used, and according to circumstances, redundant pins are remained.

Therefore, in the third embodiment, an exclusive connector pin for detecting the presence or absence and kinds for each option unit 30A, 30B is assigned thereto. Based on states (e.g., active/inactive) of signal lines to be connected with the exclusive connector pin (e.g., signal lines L5, L6), the control unit 29 determines the number of connections and the kinds of the option units.

The control unit 29 has input pins for each kind of the option units, and determines the kinds and the number of the option units on the basis of an input signal which is varied when the option units are connected. After acquiring the information, the control unit 29 determines the class as a whole of a combination of the information terminal 20 and the option units in the same way of the second embodiment. The control unit 29 sets the latching relay 28 to a state for achieving the class setting resistor value in response to the determined class. After this, the set state is maintained; the concentrator 10 recognizes the class as a whole after inserting/extracting the LAN cable 11, and then, starts the power sourcing under the appropriate characteristics.

In this way, in the third embodiment, the information terminal device determines the state of the connector pin assigned to each option unit in accordance with the states of the signal lines L5, L6. The control unit 29 of the information terminal 20 detects the kinds and the number of the option units. From the detection result, the control unit 29 determines the class of the information terminal 20 at the present time point, and sets the class setting resistor values in an autonomous way on the basis of the determination result. In this way, the information terminal device also may automatically switch the class setting resistor values and may eliminate the time and effort to manually set the class by the user.

In short, in the first embodiment, the information terminal device, which has a power reception function by LAN power sourcing and may supply power to the option units to be connected, includes a plurality of resistors in order to authenticate the class of the quantity of supplied power and may selectively set any one of the resistors through the manual operation by the user.

In the second embodiment, the control unit 29 detects the kinds and the number of the option units by mutual communication to selectively set appropriate resistor values. In the third embodiment, with the state of the connector pin monitored, the control unit 29 detects the kinds and the number of the option units to selectively set the appropriate resistor values. In a given manner, even when the maximum consumption power has been varied caused by the connection of the option units, the concentrator 10 may appropriately authenticate the power reception quantity class.

According to the first to the third embodiments, with the plurality of class setting resistors R21-R25 and the latching relay 28 to be connected thereto setting, the information terminal device may vary the power reception quantity class over three ranks in response to the change in the maximum consumption power caused by extension of the option units. Thereby, the PD may be efficiently connected to the PSE having the identical power capacities, and the necessary number of the PSEs may be decreased. Thereby, economical construction of a system using the LAN power sourcing may be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information terminal device which receives power via a communication cable from a power sourcing device recognizes a class identifying power-sourcing characteristics on the basis of response characteristics to a defined value voltage given in authentication and which is configured to connect an option unit, comprising:
a resistor unit which is disposed on a power sourcing line from the communication cable and configured to vary a resistor value;
a control unit which recognizes a class of the information terminal device itself and sets a resistor value in order to achieve response characteristics corresponding to the recognized class; and
a storing unit which stores the set resistor value.

2. The information terminal device according to claim 1, further comprising:
a user interface unit which receives an input operation of class-specifying information by a user to report the input class-specifying information to the control unit, wherein
the control unit sets a resistor value to achieve response characteristics corresponding to the reported class-specifying information to the resistor unit.

3. The information terminal device according to claim 1, wherein
the control unit determines a class as a whole including the option unit and the information terminal device itself by means of communication with the option unit, and sets a resistor value in order to achieve response characteristics corresponding to the determined class to the resistor unit.

4. The information terminal device according to claim 1, wherein
the control unit detects a state of a connector pin which connects between the information terminal device itself and the option unit, determines a class as a whole including the option unit and the information terminal device itself from the detection result, and sets a resistor value in order to achieve response characteristics corresponding to the determined class to the resistor unit.

5. The information terminal device according to claim 1, wherein
the storing unit is a latching relay, and
the resistor unit includes a plurality of resistors to be connected to the latching relay.

6. The information terminal device according to claim 1, being compliant with IEEE 802.3af.

7. An option unit which is connected to an information terminal device to be supplied power via a communication cable from a power sourcing device recognizes a class for identifying power-sourcing characteristics on the basis of a response characteristics to a defined value voltage given in authentication, comprising:
a report processing unit which reports attribute information of the option unit itself to the information terminal device.

8. The option unit according to claim 7, wherein
the report processing unit reports information needed so that the information terminal device determines a class as a whole including the option unit itself and the information terminal device by means of communication with the information terminal device.

9. The option unit according to claim 7, wherein the attribute information includes at least either a kind of the option unit itself or a power consumption quantity of the option unit itself.
